(19) United States
(12) Patent Application Publication
(10) Pub. No.: US 2026/0163816 A1
(43) Pub. Date: Jun. 11, 2026

(54) RESOURCE ALLOCATION DEVICE AND METHOD

(71) Applicant: ELECTRONICS AND TELECOMMUNICATIONS RESEARCH INSTITUTE, Daejeon (KR)

(72) Inventors: Dae Sub OH, Daejeon (KR); Bon Jun Ku, Daejeon (KR); Soo Young Kim, Daejeon (KR); Hee Wook Kim, Daejeon (KR); Hye In Lee, Daejeon (KR)

(21) Appl. No.: 19/311,423

(22) Filed: Aug. 27, 2025

(30) Foreign Application Priority Data
Dec. 10, 2024 (KR) 10-2024-0183040

(51) Int. Cl. H04L 41/16; H04L 41/14

(52) U.S. Cl. CPC H04L 41/16; H04L 41/145

(57) ABSTRACT

The present disclosure relates to a resource allocation device for a communication system, and includes a central station configured to transmit data to a user equipment of the communication system, and one or more user equipments configured to receive original data or a text prompt from the central station, wherein the central station transmits a text prompt having a smaller capacity corresponding to the original data to generative equipment having a generative AI function among the one or more user equipments instead of transmitting the original data when required resources exceed available resources, and the generative equipment that is the user equipment having a generative AI function is configured to receive the text prompt and generate the original data corresponding to the text prompt using an embedded generative AI model.

### CROSS-REFERENCE TO RELATED APPLICATION

This application claims priority to and the benefit of Korean Patent Application No. 10-2024-0183040, filed on Dec. 10, 2024, the disclosure of which is incorporated herein by reference in its entirety.

### BACKGROUND

### 1. Field of the Invention

The present disclosure relates to a resource allocation device and method for a system in which there is equipment having a function of receiving prompt data rather than original data and generating the original data.

### 2. Discussion of Related Art

Unlike a traditional communication system that transfers source data in units of bits, semantic communication (SC) is a communication scheme that focuses on transferring semantics of data, and since SC data such as text embedding or image phase information generally has a smaller capacity and is more resistant to distortion than original data, SC is attracting attention as a technology capable of significantly reducing communication delay while maintaining reliability.

FIG. 1 is an illustrative diagram illustrating a communication example of a semantic communication system and a traditional communication system. In a traditional communication system, semantics deviating from a sender's intent are transferred due to an error caused by noise, but in the semantic communication system, the same semantics are transferred even when text itself is different.

Examples of a generative artificial intelligence (AI) technique that enables the above-described SC include a text-to-image (T2I) generative AI model such as Deep AI, DALL-E, and Stable Diffusion, which is a model for decoding text prompts with high accuracy and generating images.

FIG. 2 is an illustrative diagram illustrating various generative AI models and generated images according to prompts.

Referring to FIG. 2, images that can be generated from the prompt “apple” can differ depending on the generative AI models, and as a length of the prompt increases, such as “red apples in a basket,” the prompt includes more information about the intended image, and therefore, it can be seen that more consistent generated images can be generated.

Meanwhile, as a conventional bandwidth and power allocation technology, a frequency reuse technique using multiple beams to increase spectral efficiency is adopted, particularly when frequency and power resources are very limited as in a satellite communication system. Further, an optimization allocation algorithm has been developed that allocates an adaptive transmission scheme to minimize interference between beams or with other networks and use a minimum amount of energy.

However, when required resources exceed available resources, there is a problem that services cannot be provided for an excess portion of the requested resources.

The background technology of the present disclosure is disclosed in Korean Patent Publication No. 10-2024-0150328 (published on Oct. 15, 2024).

### SUMMARY OF THE INVENTION

The present disclosure is directed to a device and method for transmitting a prompt having a much smaller data size instead of transmitting required original data having a larger size when required the resources exceed to transmit the original data. The present disclosure may be applicable to a system adopting a frequency reuse technique using multiple beams, and allowing equipment receiving the text prompt to generate the original data using an embedded generative AI model.

The present disclosure is also directed to a resource allocation device and method for a system in which there is equipment having a function of receiving prompt data rather than original data and generating the original data.

The present disclosure is also directed to a framework for a system in which there is equipment having a function of receiving prompt data rather than original data and generating the original data.

According to an aspect of the present disclosure, there is provided a resource allocation device for a communication system, including a central station configured to transmit data to a user equipment of the communication system, and one or more user equipments configured to receive original data or a text prompt from the central station, wherein the central station transmits a text prompt having a smaller capacity corresponding to the original data to generative equipment having a generative AI function among the one or more user equipments instead of transmitting the original data when required resources exceed available resources, and the generative equipment that is the user equipment having a generative AI function is configured to receive the text prompt and generate the original data corresponding to the text prompt using an embedded generative AI model.

In the present disclosure, the user equipment transmits information related to resource allocation to the central station, the information being information on a required data amount and whether the original data is generable using a generative AI, and the information related to the resource allocation is provided in response to a request from the central station or provided upon initial communication connection.

In the present disclosure, the central station performs control so that legacy user equipment having no embedded generative AI function does not access a generative cell of the communication system through specific signaling that is recognizable by the legacy user equipment in order to bar the legacy user equipment from accessing the generative cell.

In the present disclosure, the central station uses the information related to resource allocation collected from the user equipment to estimate a cell-specific required data amount vector (R_{req}), a maximum ratio of cell-specific allocatable generative equipment (uᵤₚₚ), a cell-specific channel information matrix (H), and a maximum number of generable cells (Nₐ), and initialize the number of cells to be classified as a generative cell (n (n<Nₐ)) and a cell-specific generative equipment ratio allocation vector (uᵣₐₜᵢₒ) (n=0 and uᵣₐₜᵢₒ=0).

In the present disclosure, the central station calculates a bandwidth for minimizing total use power based on the cell-specific required data amount vector (R_{req}) and the cell-specific channel information matrix (H), calculates a power value corresponding to the calculated bandwidth using a relationship formula between a bandwidth and power, and finely adjusts the allocated bandwidth and power value and ends the resource allocation when a finally calculated power value is within a range of available power in the communication system.

In the present disclosure, the central station determines generative equipment and reallocates resources using a semantic generative communication (SGC) algorithm, finely tunes the allocated bandwidth and the power value, and completes the resource allocation when the calculated power value exceeds an available power amount of the communication system and thus bandwidth and power resource allocation is not allowed within an available bandwidth and power range of the communication system.

In the present disclosure, the SGC algorithm enables the central station to perform processes of initializing generative cell search, calculating a combination of a generative cell and a generative equipment ratio, searching for a ratio vector of the generative equipment, and optimizing a required data amount and resources.

In the present disclosure, the process of initializing generative cell search is a process of: setting the number n of generative cells to 1 in an initial stage of the SGC algorithm, and executing a stage of forcibly reducing the required data amount and completing the fine-tuning and resource allocation for the allocated bandwidth and the power value when the number n exceeds a maximum number Nₐ of generable cells in the communication system.

In the present disclosure, the process of calculating a combination of a generative cell and a generative equipment ratio is a process of calculating a set A={a₁, . . . , aₖ, . . . , a_{K}} of combinations in which n generative cells are selectable from among a total of Nₐ generable cells when the number n of generative cells and the maximum number Nₐ of generable cells satisfy n≤Nₐ, and calculating a combination of generative equipment ratio vectors U=[u₁, . . . , uₗ, . . . , u_{L}].

In the present disclosure, the process of searching for a generative equipment ratio vector is a process of: starting searching for the generative equipment ratio vector from a first vector u₁ of the set U, sequentially searching for an element aₖ of the set A using the vector uₗ, performing comparison with the maximum ratio of generative equipment that is allocatable to the cell when each element of aₖ is selected as a generative cell (a_{k,j}=1) during this search, and updating the generative equipment ratio vector uᵣₐₜᵢₒ when the condition is satisfied, and setting the generative equipment ratio of the cell to 0 when each element of aₖ is not selected as the generative cell during this search (a_{k,j}=0).

In the present disclosure, the process of optimizing the required data amount and resources is a process of updating the required data amount vector R_{req} based on a generative equipment ratio vector uᵣₐₜᵢₒ when the generative equipment ratio vector uᵣₐₜᵢₒ is completed, checking whether the bandwidth and power of each cell calculated using a preset optimization calculation formula satisfies an available power requirement of the system, completing the fine-tuning and resource allocation when the available power requirement is satisfied, and performing the search on a next combination when the available power requirement is not satisfied.

In the present disclosure, when the process of optimizing a required data amount and resources is performed, a repetition and end process can be performed, and the repetition and end process is a process of incrementing the number n of generative cells by 1 to start searching for the generative equipment ratio vector again when the search for all combinations is completed but the resource allocation is not allowed, repeatedly performing this until the maximum number Nₐ of generable cells does not satisfy a condition n≤Na, and applying a required data amount reduction algorithm to complete the resource allocation when the resource allocation is not allowed even in the case of a combination for the maximum number of generable cells (n=Na).

According to another aspect of the present disclosure, there is provided a resource allocation method for a communication system, including: transmitting, by a central station of the communication system, data to one or more user equipments, and receiving, by the one or more user equipments, original data or a text prompt from the central station, wherein the transmitting of the data to the one or more user equipments further includes transmitting, by the central station, a text prompt having a smaller capacity corresponding to the original data to generative equipment having an embedded generative AI function among the one or more user equipments, instead of transmitting the original data, when required resources exceed available resources, and receiving, by the generative equipment as user equipment having an embedded generative AI function, the text prompt and generating the original data corresponding to the text prompt using an embedded generative AI model.

In the present disclosure, in order for the central station to transmit data to the one or more user equipments, the central station receives information related to the resource allocation from the user equipment, calculates a bandwidth for minimizing total use power based on the information related to the resource allocation such as a vector representing the required amount of data for all available cells and a matrix representing channel information for all available cells, calculates a power value corresponding to the calculated bandwidth using a relationship formula between a bandwidth and power, and finely adjusts the allocated bandwidth and power value and ends the resource allocation when a finally calculated power value is within a range of available power in the communication system, and determines generative equipment and reallocates resources using a semantic generative communication (SGC) algorithm, finely tunes the allocated bandwidth and the power value, and completes the resource allocation when the calculated power value exceeds an available power amount of the communication system and thus bandwidth and power resource allocation is not allowed within an available bandwidth and power range of the communication system.

In the present disclosure, the SGC algorithm enables the central station to perform processes of: initializing generative cell search, calculating a combination of a generative cell and a generative equipment ratio, searching for a ratio vector of the generative equipment, and optimizing a required data amount and resources.

In the present disclosure, the process of initializing generative cell search is a process of: setting the number n of generative cells to 1 in an initial stage of the SGC algorithm, and executing a stage of forcibly reducing the required data amount and completing the fine-tuning and resource allocation for the allocated bandwidth and the power value when the number n exceeds a maximum number Nₐ of generable cells in the communication system.

In the present disclosure, the process of calculating a combination of a generative cell and a generative equipment ratio is a process of calculating a set A={a₁, . . . , aₖ, . . . , a_{K}} of combinations in which n generative cells are selectable from among a total of Nₐ generable cells when the number n of generative cells and the maximum number Nₐ of generable cells satisfy n≤Nₐ, and calculating a combination of generative equipment ratio vectors U=[u₁, . . . , uₗ, . . . , u_{L}].

In the present disclosure, the process of searching for a generative equipment ratio vector is a process of: starting searching for the generative equipment ratio vector from a first vector u₁ of the set U, sequentially searching for an element aₖ of the set A using the vector uₗ, performing comparison with the maximum ratio of generative equipment that is allocatable to the cell when each element of aₖ is selected as a generative cell (a_{k,j}=1) during this search, and updating the generative equipment ratio vector uᵣₐₜᵢₒ when the condition is satisfied, and setting the generative equipment ratio of the cell to 0 when each element of aₖ is not selected as the generative cell during this search (a_{k,j}=0).

In the present disclosure, the process of optimizing the required data amount and resources is a process of updating the required data amount vector R_{req} based on a generative equipment ratio vector uᵣₐₜᵢₒ when the generative equipment ratio vector uᵣₐₜᵢₒ is completed, checking whether the bandwidth and power of each cell calculated using a preset optimization calculation formula satisfies an available power requirement of the system, completing the fine-tuning and resource allocation when the available power requirement is satisfied, and performing the search on a next combination when the available power requirement is not satisfied.

In the present disclosure, when the process of optimizing a required data amount and resources is performed, a repetition and end process can be further performed, and the repetition and end process is a process of incrementing the number n of generative cells by 1 to start searching for the generative equipment ratio vector again when the search for all combinations is completed but the resource allocation is not allowed, repeatedly performing this until the maximum number Nₐ of generable cells does not satisfy a condition n≤Na, and applying a required data amount reduction algorithm to complete the resource allocation when the resource allocation is not allowed even in the case of a combination for the maximum number of generable cells (n=Na).

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an illustrative diagram illustrating a communication example of a semantic communication system and a traditional communication system;

FIG. 2 is an illustrative diagram illustrating various generative AI models and generated images according to a prompt;

FIG. 3 is an illustrative diagram illustrating a schematic configuration of a satellite communication framework in which there is equipment with embedded generative AI according to an embodiment of the present disclosure;

FIG. 4 is a flowchart illustrating a resource allocation method considering equipment with embedded generative AI according to an embodiment of the present disclosure;

FIG. 5 is a flowchart illustrating a method by which a satellite central station bars an existing legacy user equipment (UE) from accessing a cell according to an embodiment of the present disclosure;

FIG. 6 is a flowchart illustrating a method by which the satellite central station bars a latest UE that does not provide a function from accessing a cell according to an embodiment of the present disclosure;

FIG. 7 is a flowchart illustrating a more specific execution process of a semantic generative communication (SGC) algorithm in FIG. 4;

FIG. 8 is an illustrative diagram illustrating a table showing a value A={a₁, . . . , aₖ, . . . , a_{K}} calculated as a value of n increases from 1 to Nₐ when a total number of cells is N=4, the maximum number of generable cells is Nₐ=3, and uᵤₚₚ=[0 10 17 30] in FIG. 7;

FIG. 9 is an illustrative diagram illustrating a table showing a value U={u₁, . . . , uᵢ, . . . , u_{L}} calculated as the value of n increases from 1 to Nₐ when the total number of cells is N=4, the maximum number of generable cells is Nₐ=3, and uᵤₚₚ=[0 10 17 30] in FIG. 7; and

FIG. 10 is an illustrative diagram illustrating possible (n, l, k) and a generative equipment ratio vector uᵣₐₜᵢₒ in FIG. 9.

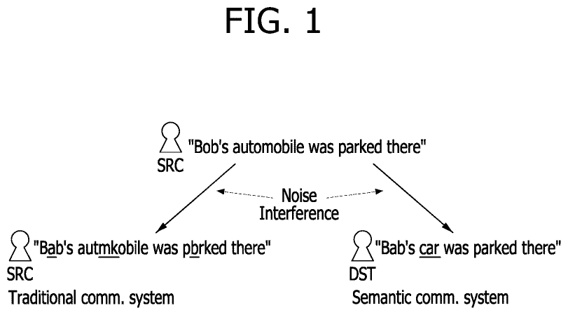

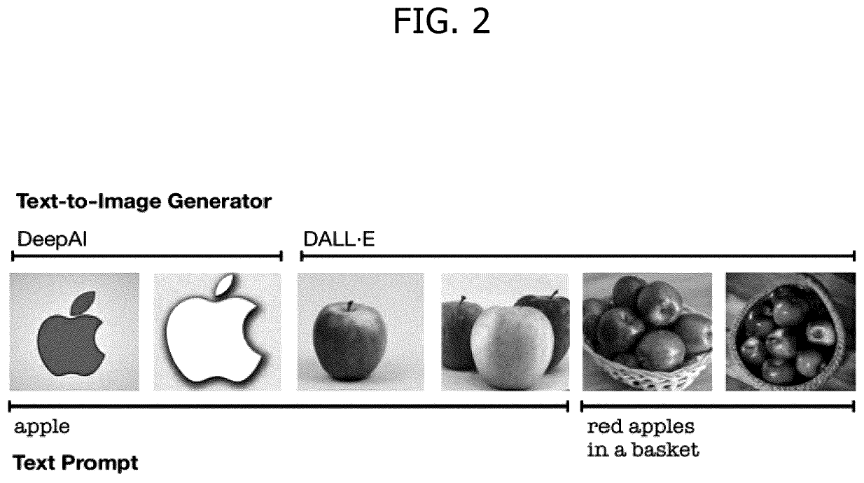

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both.

Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc, and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals. In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, a resource allocation device and method according to embodiments of the present disclosure will be described.

The embodiments relates to a communication framework and a resource allocation method that enable communication to be performed using minimum power by ascertaining whether there is equipment having an embedded generative AI function when required resources exceed available resources of a communication system adopting a frequency reuse technique using multiple beams, transmitting a text prompt having a small data size to selected equipment (that is, equipment having an embedded generative AI function) among equipment instead of transmitting requested original data having a relatively large capacity, and generating the original data using a generative AI model embedded inside the equipment (that is, equipment having an embedded generative AI function).

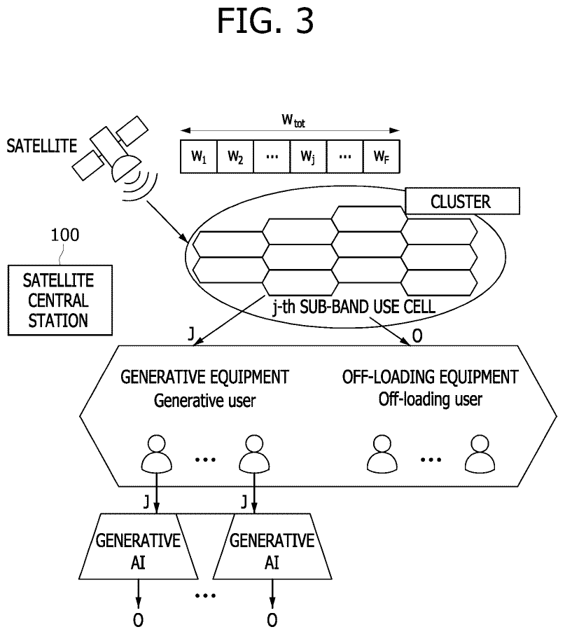

FIG. 3 is an illustrative diagram illustrating a schematic configuration of a satellite communication framework in which there is equipment with generative AI according to an embodiment of the present disclosure.

However, it should be noted that the present disclosure is not intended to be limited to a satellite communication system, and in order to help understanding of the present disclosure, the present disclosure will be described using a satellite communication system with greatly limited power and frequency resources as an example.

In a multi-beam satellite communication system that adopts a frequency reuse scheme, an entire available bandwidth is divided into F sub-bands, different bandwidths are allocated to adjacent cells, clusters of cells are created by the F cells, and frequencies are reused in adjacent clusters.

In one beam (cell) of the satellite communication system, there are generative equipment having a function of generating original data using embedded generative AI (or generation AI) and conventional off-loading equipment that does not have this function (that is, the function of generating the original data using the generative AI).

The generative equipment receives a text prompt I, not original data, from a satellite and generates the original data.

On the other hand, the off-loading equipment receives original data O directly from the satellite.

In this case, a data size of the text prompt I is much smaller than that of the original data O, which greatly reduces power consumed for communication.

However, even when the generative equipment receives the text prompt I including sufficient description of the original data and generates an image using embedded generative AI, the image may not be completely the same as the original data, and therefore it is necessary to determine an appropriate allocation ratio of a generative cell (that is, a cell that supports a generative AI model or data processing) and generative equipment (that is, generative equipment having a function of generating original data using generative AI) in consideration of trade-off between power efficiency and data quality.

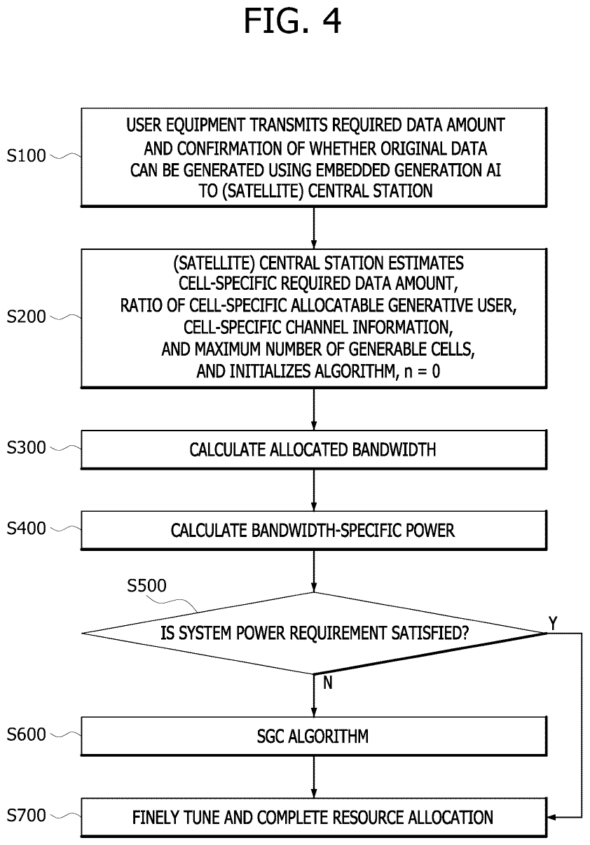

FIG. 4 is a flowchart illustrating a resource allocation method considering equipment with embedded generative AI according to an embodiment of the present disclosure.

Referring to FIG. 4, first, each user equipment transmits information on a required data amount and whether original data can be generated using the embedded generation AI to a satellite central station 100 (S100).

In this case, the concept of the satellite central station 100 may include a satellite.

Here, each user equipment (UE) may provide the information in response to a request from the satellite central station, or may provide related information upon initial communication connection without a request.

In this case, when the satellite central station 100 requests the required data amount and confirmation of whether the original data can be generated using the generation AI embedded in the user equipment from the user equipment, the request may be made through, as related signaling, common signaling such as a system information message (SIB) and a common radio resource control (RRC) message, or may be made through dedicated signaling (a signal transmission scheme that can be applied to specific user equipment) such as a dedicated RRC message or downlink control information (DCI)/uplink control information (UCI).

The user equipment may transmit the information through an uplink control channel such as a physical uplink control channel (PUCCH) or may transmit the information through an uplink data channel such as a physical uplink shared channel (PUSCH).

In FIG. 4, simultaneously exchanging information for resource allocation for generative AI-based communication (for example, the required data amount and whether original data can be generated using the embedded generative AI) between the satellite central station 100 and the user equipment is considered.

However, it is also possible to sequentially exchange such information (for example, the required data amount and whether original data can be generated using the embedded generative AI) between the satellite central station 100 and the user equipment.

For example, the user equipment may provide the satellite central station 100 with information on whether the equipment provides such a function (for example, a function of generating original data using the embedded generation AI) upon an initial connection, and based on the information, the satellite central station 100 may distinguish between equipment that provides the function (for example, the function of generating original data using the embedded generation AI) and equipment that does not provide the function, and request required data amount information exclusively (that is, dedicatedly).

Further, only some information required for resource allocation for generative AI-based communication may be exchanged between the satellite central station 100 and the user equipment.

For example, the satellite central station 100 and the user equipment may exchange only the information on whether the equipment provides the function (for example, the function of generating original data using the embedded generation AI), and the required data amount information of each user equipment may be predicted independently based on, for example, traffic information that the satellite central station 100 currently provides to each user.

On the other hand, in a cell in which the satellite central station 100 provides a communication framework function that takes into account equipment with embedded generative AI, there may be existing legacy user equipment that does not provide the function (for example, the function of generating original data using the embedded generative AI) and cannot recognize whether the cell supports the function (for example, the function of generating original data using the embedded generative AI), latest user equipment that does not provide the function (for example, the function of generating original data using the embedded generative AI) but can recognize whether the cell supports the function (for example, the function of generating original data using the embedded generative AI), and latest user equipment that provides the function (for example, the function of generating original data using the embedded generative AI).

In this scenario, since the existing legacy user equipment cannot recognize whether the cell supports the function (for example, the function of generating original data using the embedded generative AI), the satellite central station 100 needs to “bar” the existing legacy user equipment from accessing the cell.

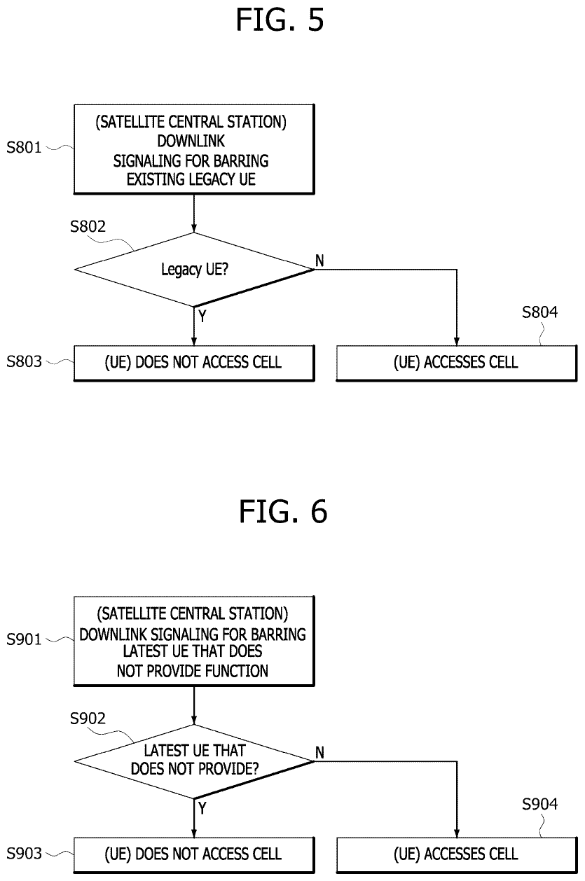

To this end, the satellite central station 100 can prevent existing legacy UE from accessing the cell through a signaling method that can be recognized by the existing legacy UE (for example, an existing legacy user barring procedure, or use of an existing bar bit of an SIB or common RRC message) (see FIG. 5).

FIG. 5 is a flowchart showing a method by which the satellite central station 100 bars the existing legacy UE from accessing the cell according to an embodiment of the present disclosure. The satellite central station 100 transmits downlink signaling for barring the existing legacy UE (S801), and when the legacy UE receives this downlink signaling (Y in S802), the legacy UE does not access the cell (S803), and only user equipment that does not receive the downlink signaling (N in S802) (that is, non-legacy UE) accesses the cell (S804).

Next, when latest user equipment that supports the function (for example, the function of generating original data using the embedded generative AI) and latest user equipment that does not support the function are both allowed to access the cell and generative AI-based resource allocation according to the present embodiment is performed, it may be applied similarly to FIG. 4.

Lastly, when the satellite central station 100 allows only the latest user equipment that supports the function (for example, the function of generating original data using the embedded generative AI) to access the cell and performs the generative AI-based resource allocation of the present disclosure, it is also necessary to bar the latest user equipment that does not support the function from accessing the cell (see FIG. 6).

FIG. 6 is a flowchart showing a method by which the satellite central station 100 bars a latest user equipment (UE) that does not provide the function from accessing the cell according to an embodiment of the present disclosure, the satellite central station 100 transmits downlink signaling for barring a latest UE that does not provide a function (for example, the function of generating original data using the embedded generative AI) (S901), and when the latest UE that does not provide the function (for example, the function of generating original data using the embedded generative AI) receives this downlink signaling (Y in S902), the latest UE that does not provide the function does not access the cell (S903). Only a user equipment that does not receive the downlink signaling (N in S902) (that is, a user equipment that is not the latest UE that does not provide the corresponding function) accesses the cell (S904).

For example, the satellite central station 100 may add a new bar bit for “barring” the cell from accessing the latest user equipment that does not support the function (for example, the function of generating original data using the embedded generation AI) to an existing SIB or RRC message or define a new SIB or RRC message to perform common signaling (a signal transmission scheme that can be applied equally to all user equipment), thereby preventing the latest user equipment that does not support the function (for example, the function of generating original data using the embedded generation AI) from accessing the cell.

Referring back to FIG. 4, the satellite central station 100 estimates a cell-specific required data amount vector (R_{req}), a maximum ratio of cell-specific allocatable generative equipment (uᵤₚₚ), a cell-specific channel information matrix (H), and a maximum number of generable cells (Nₐ) using the information collected from the equipment, and initializes the number to be classified as generative cells (n (n<Nₐ)) and a cell-specific generative equipment ratio allocation vector (uᵣₐₜᵢₒ) (n=0 and uᵣₐₜᵢₒ=0) (S200).

The satellite central station 100 calculates a bandwidth for minimizing total use power based on the cell-specific required data amount vector (R_{req}) and the cell-specific channel information matrix (H) using an optimization technique (S300), and calculates a power value corresponding to the calculated bandwidth using a relationship equation between the bandwidth and the power (S400).

When a finally calculated power value is within a range of power available in the system (Y of S500), the satellite central station 100 finely tunes an allocated bandwidth and power value and ends the resource allocation (S700).

When the calculated power value exceeds an available power amount of the system (N of S500), that is, when bandwidth and power resource allocation are not within the available bandwidth and range of power of the system, generative AI equipment is determined and a procedure of reallocating resources is performed using a semantic generative communication (SGC) algorithm (S600), the allocated bandwidth and power value are fine-tuned, and the resource allocation is completed (S700).

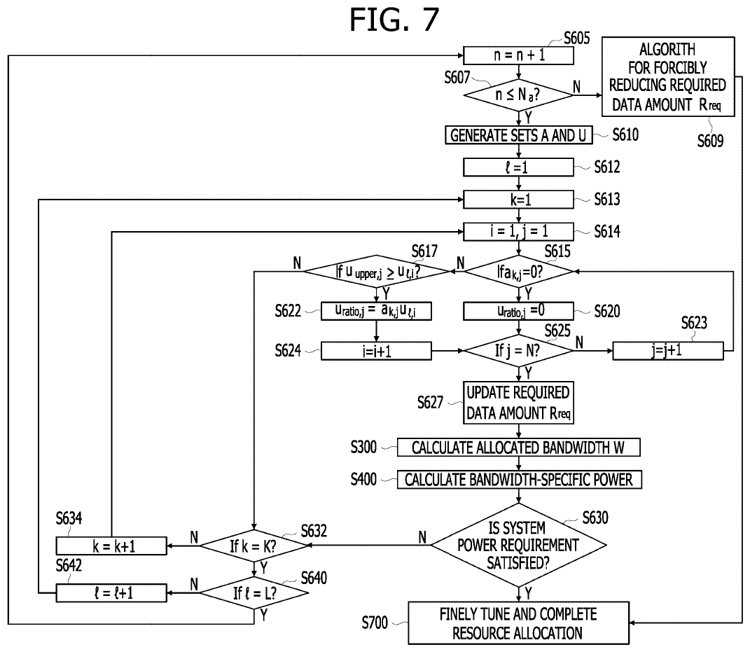

FIG. 7 is a flowchart illustrating a more specific execution process of a semantic generative communication (SGC) algorithm in FIG. 4.

Referring to FIG. 7, it is determined whether resource allocation is possible while increasing the number of generable cells by one by one among all cells that are resource allocation targets.

An object of the present embodiment is to satisfy a required service data amount while keeping a minimum ratio of generative equipment.

Therefore, in this process, sequential search is performed by incrementing the number of generative cells by one.

In an SGC algorithm stage, the number n of cells selected as the generative cells initialized in S200 of FIG. 4 is incremented by one and the SGC algorithm is started (S605).

In this case, when n>Nₐ, this means that the allocated number of generative cells has been exceeded the maximum number of generable cells in the satellite communication system, and therefore an algorithm for forcibly reducing the required data amount is executed (S609) and fine-tuning and resource allocation are completed (S700).

Here, the fine-tuning and the resource allocation are tasks of finely adjusting a ratio of generative equipment within a selected generative cell so that a cell-specific bandwidth and power resources are optimally used, and are tasks of adjusting the ratio of generative equipment within the designated generative cell and allocating bandwidths and power to be used in the respective cells so that total use power within the satellite communication system is the smallest.

When the number of cells selected as generative cells is smaller than the maximum number of generable cells, that is, when n≤Nₐ is satisfied (S607), the selection and allocation of generative cells are attempted sequentially in ascending order from a case in which a total sum of generative equipment ratios is the smallest.

First, as K=NₐCₙ, that is, the number of combinations in which n of a total of Nₐ generable cells can be selected as generative cells, a set of possible generative cell selection vectors A=[a₁, . . . , aₖ, . . . , a_{K}] and a set of generative equipment ratio vectors U={u₁, . . . , uᵢ, . . . , u_{L}} that is allocatable to a generative cell selection combination are calculated as follows (S610).

First, the set A is expressed as in the following Formula 1.

$$𝒜 = \{ {a}_{1} , … , {a}_{k} , … , {a}_{K} \} , \qquad [ Formula 1 ]$$

$${a}_{k} \cdot {u}_{upp}^{T} \leq {a}_{k + 1} \cdot {u}_{upp}^{T} ,$$

$${a}_{k , j} ∈ [ 0 , 1 ] ,$$

$${\sum }_{j}^{N} {a}_{k , j} = n ,$$

$$j = 1 , … N$$

Here, aₖ is a vector element constituting the set A, and each vector element consists of 0 or 1. That is, a^{k,j} is an i-th element of aₖ, a_{k,j}=1 means that the j-th cell is selected as the generative cell, and a_{k,j}=0 means that the j-th cell is not selected. Therefore,

$${\sum }_{j}^{N} {a}_{k , j} = n .$$

Further, a maximum ratio vector of cell-specific allocatable generative equipment uᵤₚₚ is a vector having, as elements, a total of N maximum ratios of cell-specific allocatable generative equipment.

Therefore, a₁uᵤₚₚ^{T} is a smallest sum of the maximum ratios of allocatable generative equipment in the K combinations in which n of the Nₐ cells can be selected, and aₖuᵤₚₚ^{T} is a k-th sum of the maximum ratios of allocatable generative equipment among the K combinations.

Since the vector uᵤₚₚ is a vector having, as elements, the total of maximum ratios of N cell-specific allocatable generative equipment, a condition aₖuᵤₚₚ^{T}≤aₖ₊₁uᵤₚₚ is satisfied, and sequential inner product values of the element vectors of the set A and uᵤₚₚ are a condition that the maximum ratio of allocatable generative equipment within the entire cell are determined in ascending order.

Next, the set U={u₁, . . . , uᵢ, . . . , u_{L}} of L=(Na)\hat{ }2 generative equipment ratio vectors that is allocatable to the generative cell selection combination determined as A={a₁, . . . , aₖ, . . . , a_{K}} is calculated as in Equation 2.

$$𝒰 = \{ {u}_{1} , … , {u}_{l} , … , {u}_{L} \} , \qquad [ Formula 2 ]$$

$${\sum }_{i}^{n} {u}_{l , i} \leq {\sum }_{i}^{n} {u}_{l + 1 , i} ,$$

$${u}_{l , i} ∈ {u}_{upp}$$

$$i = 1 , … , n$$

Here, uₗ is an l-th vector element of the set U having a size of 1×n, u_{l,i} is an i-th element of uₗ, and u_{l,i} means a generative equipment ratio to be allocated to a cell with a_{k,j}=1 of aₖ, that is, a cell selected as the generative cell. In this case, the generative equipment ratio uji to be allocated has a value of one of the elements of uᵤₚₚ (u_{l,i}∈uᵤₚₚ).

Further, since the vectors constituting the set U={u₁, . . . , uₗ, . . . , u_{L}} are configured to satisfy the condition

$${\sum }_{i}^{n} {u}_{l , i} \leq {\sum }_{i}^{n} {u}_{l + 1 , i} ,$$

all the generative equipment allocation ratios of the system are arranged in ascending order so that a sum of the elements of uₗ₊₁ is always greater than a sum of the elements of uₗ.

In the present embodiment, the search is attempted in ascending order of a sum of the generative equipment allocation ratios using the set U={u₁, . . . , uₗ, . . . , u_{L}} and a generative cell selection combination vector aₖ configured in this manner.

As described above, if the set A and the set U are calculated, when the sum of the generative equipment ratios is the smallest, that is, using a first element vector u₁ of the set U, a generative cell and generative equipment ratio is initialized and it is determined whether the resource allocation is possible.

To this end, an index value indicating element vectors of the set U is set to i=1 (S612).

In this case, uₗ has n elements u_{l,1}, . . . , u_{l,n}

Next, an index value indicating element vectors constituting the set A is set to k=1 in order to sequentially search for the element vectors constituting the set A in ascending order of the sum of ratios of generative equipment to be allocated to n generative cells using the vector uᵢ (S613).

In order to determine the cell-specific generative equipment allocation ratio vector uᵣₐₜᵢₒ, an index value i indicating n elements constituting uₗ is initialized to 1, and an index j indicating elements of aₖ is initialized to 1 (S614).

In this case, when the j-th element of aₖ is 1, that is, the cell corresponding to the j-th element is the generative cell (a_{k,j}=1) (S615), and when uji is equal to or smaller than u_{upp,j}, that is, u_{l,i} is equal to or smaller than the maximum ratio of generative equipment that can be assigned to the cell corresponding to the j-th element (S617), a value of the j-th element u_{ratio,j} of the cell-specific generative equipment allocation ratio vector uᵣₐₜᵢₒ is assigned to u_{l,i} (S622), and the index value i is incremented by 1 (S624).

When the j-th element of aₖ is 0 (Y of S615), that is, when the cell is not a generative cell (S615), u_{ratio,j} is set to 0 (u_{ratio,j}=0) (S620).

When a value of the j-th element of the vector uᵣₐₜᵢₒ is determined through operation S622 or S620, it is checked whether an index value j has reached N in order to check whether a u_{ratio,j} value has been assigned to all N elements constituting the vector u_{ratio,j} (S625).

Otherwise (N of S625), the j value is incremented by 1 (S623) and the process is repeatedly performed from operation S615 to determine the values of the next elements.

When j=N in operation S625 by setting values of all N elements, this means that the equipment allocation ratio vector uᵣₐₜᵢₒ is completed. Therefore, a new required data amount vector R′req is calculated according to uᵣₐₜᵢₒ, and R_{req} is updated (R_{req}=R′_{req} and |R′_{req}|<|R_{req}|) (S627).

The bandwidth for minimizing total use power is calculated for the updated R_{req} using the optimization technique (S300), and the power value corresponding to the calculated bandwidth is calculated using the relationship equation between the bandwidth and the power (S400).

A bandwidth for minimizing total use power for the updated R_{req} is calculated using the optimization technique (S300), and a power value corresponding to the calculated bandwidth is calculated using a relationship formula between the bandwidth and the power (S400).

When the finally calculated power value is within a range of power available in the system (Y of S630), the allocated bandwidth and power value are fine-tuned and resource allocation is completed (S700).

When a system power requirement is not satisfied (N of S630), it is checked whether a value of an index k has reached K in order to check whether the search has been completed for all K generative cell selection combination vectors (S632).

When the value of the index k has not reached K (N of S632), the value of k is incremented by 1 (S634), and the process is repeatedly performed from operation S614.

When the value of the index k has reached K (Y of S632), it is checked whether an index value 1 has reached L (S640) in order to check whether the resource allocation has been attempted for all the generative equipment ratio vectors.

When the index value 1 has not reached L (N of S640), the value 1 is incremented by 1 (S642), and the process is repeatedly performed from operation S613.

When the index value 1 has reached L (Y of S640), the process is repeatedly performed from operation S605 of incrementing the number n of cells selected as generative cells by 1.

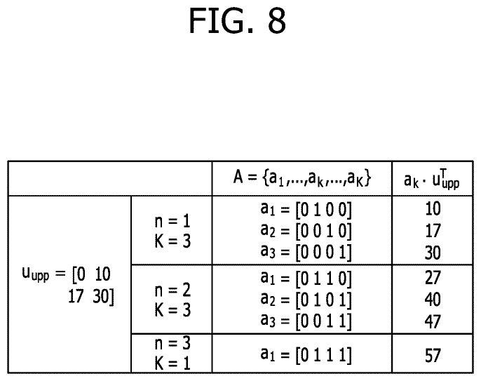

For example, when the total number of cells is N=4, the maximum number of generable cells is Nₐ=3, and uᵤₚₚ=[0 10 17 30], values of A={a₁, . . . , aₖ, . . . , a_{K}} and aₖuᵤₚₚ^{T} calculated as the value of n increases from 1 to Nₐ are as shown in the table illustrated in FIG. 8.

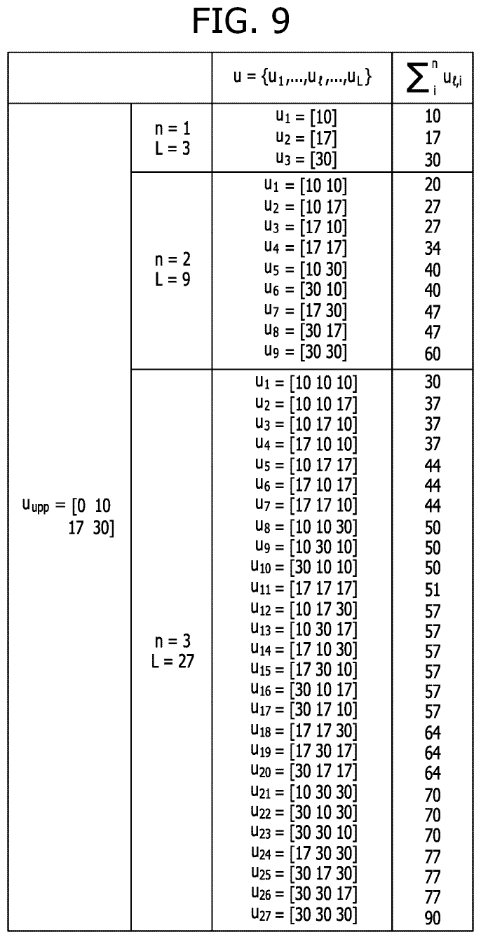

When the total number of cells is N=4, the maximum number of generable cells is Nₐ=3, and uᵤₚₚ=[0 10 17 30], U={u₁, . . . , uₗ, . . . , u_{L}} calculated as the value of n increases from 1 to Nₐ is as shown in the table illustrated in FIG. 9.

When the SGC algorithm stage is entered, the number of generative cells is incremented by one (S105), and the SGC algorithm is started, an attempt is made to assign the generative equipment ratio u_{i,1} (i=1) of the generative equipment ratio vector uₗ (l=1) to a_{l,1} (j=1) of the generative cell selection vector a₁ (k=1) for one generative cell (n=1).

According to an initial setting, (n,l,k,i,j)=(1,1,1,1,1) is set, and in this case, a_{l,1}=0 (S615), which means that the cell corresponding to the first element is not the generative cell.

Therefore, the first element of the generative equipment ratio vector is designated as u_{ratio,1}=0 (S620), it is checked whether the index value j has reached N in order to check whether values have been allocated to all of a total of N elements of the equipment allocation ratio vector uᵣₐₜᵢₒ (S625), the j value is incremented by 1 to determine values of the next elements when the index value j has not reached N (S623), and the process is repeatedly performed from operation S615.

In the present embodiment, when j=2, the process is repeatedly performed for (n,l,k,i,j)=(1,1,1,1,2).

Since the second cell is selected as the generative cell, that is, a_{l,2}=1 (S615), it is checked whether the allocation ratio u_{l,2}=10 exceeds the maximum ratio u_{upper,2} of the allocatable generative equipment of the cell corresponding to the second element of uᵤₚₚ, that is, the (j=2)-th cell (S617), and when the allocation ratio does not exceed the maximum ratio, u_{ratio,2}=u_{1,2}=10 is designated (S622).

Thereafter, the i value is incremented by one (i=i+1) (S624), and it is checked whether all the element values of the uᵣₐₜᵢₒ vector have been designated, that is, j=N (S625).

When j has not reached N, j is incremented by one (j=j+1) (S623), and the flow illustrated in FIG. 7 is performed again for (n,l,k,i,j)=(1,1,1,2,3).

Since a third cell is a_{1,3}=0, u_{ratio,3}=0 is designated through S615, S620, S625, and S623.

When (n, l, k, i, j)=(1,1,1,3,4), u_{ratio,4}=0 is designated in S620 via S615, S625 is satisfied, that is, the generative equipment ratio has been designated for all of the N elements, and therefore the generative equipment ratio becomes uᵣₐₜᵢₒ=[0,10,0,0].

A value of the required data amount vector R_{req} is updated using the designated uᵣₐₜᵢₒ (S627), and the process proceeds to an operation of calculating an allocation bandwidth (w) for an updated required data amount (S300) and an operation of calculating bandwidth-specific power (S400).

That is, the second cell is selected as the generative cell, the generative equipment ratio is set to 10%, the required data amount R′_{req} reduced by an amount corresponding to the generative equipment ratio of 10% is calculated, and then R_{req} is updated (R_{req}=R′_{req} and |R′_{req}|<|R_{req}|) (S627).

For the updated R_{req}, resource allocation for a bandwidth for minimizing the total use power is attempted using the optimization technique.

In this case, when the system power requirement is not satisfied (N of S630), it is checked whether resource allocation has been attempted for all the generative cell selection vectors (S632), the value of k is incremented by 1 (S634), and then the algorithm is repeatedly performed from operation S614 for the next generative cell selection combination k=2, that is, for (n,l,k,i,j)=(1, 1, 2, 1,1).

When k=K through this process (S632), it is checked whether the resource allocation has been attempted for all the generative equipment ratio vectors u₁ (S640), the value of 1 is incremented by 1 so that 1=2 when the resource allocation has not been attempted (S642), and then the process is repeatedly performed from operation S613 for (n,l,k,i,j)=(1,2,1,1,1).

When 1=L through this process (S640), but resource allocation is not allowed, the value of n is incremented by 1 to become 2 (S605) and the process is repeatedly performed from operation S605 for (n,l,k,i,j)=(2,1,1,1,1).

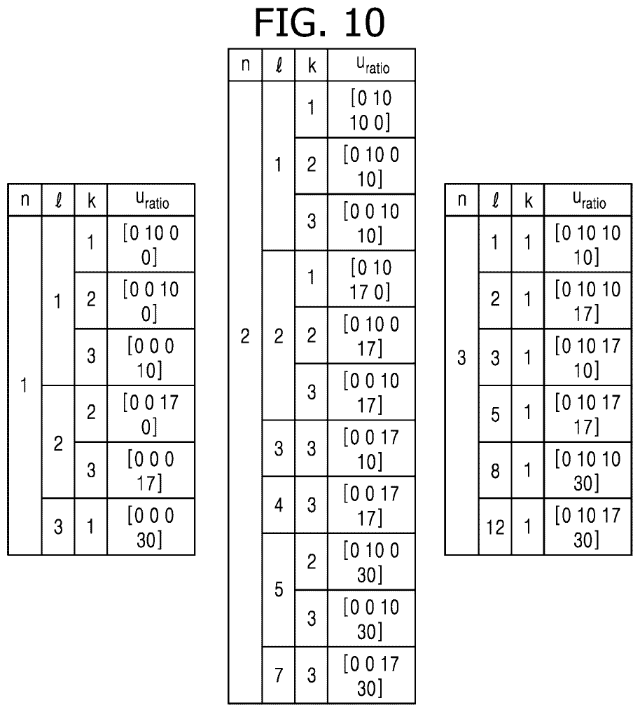

The possible (n, l, k) and the generative equipment ratio vector uᵣₐₜᵢₒ in the example of the FIG. 9 according to the present embodiment are as shown in the table in FIG. 10.

In this case, since a condition of u_{upper,j}≥u_{l,i} (S617) is violated in the case of (n, l, k)=(1, 2, 1), (1, 3, 2), (1, 3, 3), (2, 3, 1), (2, 3, 2), (2, 4, 1), (2, 4, 2), (2, 5, 1), (2, 65, 12), (2, 6, 2), (2, 6, 3), (2, 7, 1), (2, 7, 2), (3, 4, 1), (3, 6, 1), (3, 7, 1), (3, 9, 1), (3, 10, 1), (3, 11, 1), (3, 13-27, 1), the allocation bandwidth calculation (S300) and the bandwidth-specific power calculation (S400) cannot be attempted.

As described above, in the present embodiment, resource allocation (S300) and bandwidth-specific power calculation (S400) are sequentially attempted for the cell-specific generative equipment ratio allocation vector uᵣₐₜᵢₒ determined by (n, l, k), and in this case, the generative equipment ratio allocation vector uᵣₐₜᵢₒ determined by (n, l, k) is applied to calculate the allocated bandwidth (S300), and when the calculated bandwidth-specific power (S400) satisfies the system power requirement (Y of S630), the fine-tuning and resource allocation are completed (S700).

Further, if the system power requirement is not satisfied even when the resource allocation has been attempted up to all (n,l,k) of the maximum number of possible generative cells (n=Nₐ), that is, up to (n,l,k)=(3,27,1) in the embodiment (N of S630), the fine-tuning and resource allocation are completed through the algorithm (S609) for forcibly reducing the required data amount through operations S632, S640, S605, and S607 (S700).

In other words, the SGC algorithm is a process of initializing generative cell search, and in the initial operation S605, the number n of generative cells is set to 1 and the SGC algorithm is started. In this case, when the value of n exceeds a maximum number Nₐ of generable cells in the communication system (N of S607), the operation S609 for forcibly reducing the required data amount is executed, and then the fine-tuning of the allocated bandwidth and power value and the resource allocation are completed (S700).

Further, as a process for calculating a combination of the generative cells and generative equipment ratios, when the condition n≤Nₐ is satisfied (Y of S607), a set of combinations A={a₁, . . . , aₖ, . . . , a_{K}} in which n generative cells can be selected from among a total of Nₐ generable cells is calculated (S610), a combination of generative equipment ratio vectors U=[u₁, . . . , uₗ, . . . , u_{L}] is calculated (S610), the respective ratio vectors are sorted in ascending order, and in this process, each vector aₖ of A and each vector uₗ of u become criteria for generative cell selection and equipment ratio allocation.

Further, in a process for searching for a generative equipment ratio vector, the search starts from a first vector u₁ of the set U (S612), and search is sequentially performed for the element aₖ of the set A using the vector u (S613). When each element of aₖ is selected as a generative cell in this process (a_{k,j}=1) (N of S615), a comparison with the maximum ratio of generative equipment that is allocatable to the cell is performed (S617), and when the condition is satisfied, the generative equipment ratio vector uᵣₐₜᵢₒ is updated (S622).

However, when the element is not selected as the generative cell (a_{k,j}=0) (Y of S615), the generative equipment ratio of the cell is set to 0 (S620).

Further, in a required data amount and resource optimization process, when the generative equipment ratio vector uᵣₐₜᵢₒ is completed, the required data amount vector R_{req} is updated based on the generative equipment ratio vector (S627). Thereafter, the bandwidth and power of each cell are calculated using a preset optimization formula (S300 and S400), and it is checked whether optimally calculated power satisfies an available power requirement of the system (S630). When the power satisfies the available power requirement of the system (Y of S630), the fine-tuning and resource allocation are completed (S700), and when the power does not satisfy the available power requirement of the system (N of S630), the search proceeds to the next combination (S632).

Finally, in a repetition and end process, when the search for all combinations is completed but the resource allocation is not allowed (Y of S640), the number n of generative cells is incremented by 1 (S605), and the search starts again. This process is repeatedly performed until the condition n≤Nₐ is not satisfied. When the resource allocation is not allowed even in the case of a combination for the maximum number of generable cells (N of S630), a required data amount reduction algorithm (S609) is applied to complete the resource allocation (S700).

Accordingly, in the present embodiment, it is possible to minimize the required data amount through a process of adjusting the combination of generable cells and the ratio of generative equipment, and to allocate an optimal bandwidth and power within the limited resources, thereby efficiently utilizing the resources of each cell and improving the overall performance of the satellite communication system.

Thus, in the present embodiment, it is possible to efficiently allocate limited frequency resources and power resources when there is equipment having a function of receiving prompt data rather than original data and generating the original data using an embedded generative artificial intelligence (AI) in a multi-beam system in which a frequency reuse technique is used.

According to an aspect of the present disclosure, it is possible for all users to receive services when required data exceeds a capacity that can be provided by the system.

According to the present disclosure, it is possible not only to increase the reliability of the system, but also to reduce energy consumption for communication in the system.

What is claimed is:

1. A resource allocation device for a communication system, comprising:
a central station configured to transmit data to a user equipment of the communication system; and
one or more user equipments configured to receive original data or a text prompt from the central station,
wherein the central station transmits a text prompt having a smaller capacity corresponding to the original data to generative equipment having a generative AI function among the one or more user equipments instead of transmitting the original data when required resources exceed available resources, and
the generative equipment that is the user equipment having a generative AI function is configured to receive the text prompt and generate the original data corresponding to the text prompt using an embedded generative AI model.

2. The resource allocation device of claim 1,
wherein the user equipment transmits information related to resource allocation to the central station, the information being information on a required data amount and whether the original data is generable using a generative AI, and
the information related to the resource allocation is provided in response to a request from the central station or provided upon initial communication connection.

3. The resource allocation device of claim 1, wherein the central station performs control so that legacy user equipment having no embedded generative AI function does not access a generative cell of the communication system through specific signaling that is recognizable by the legacy user equipment in order to bar the legacy user equipment from accessing the generative cell.

4. The resource allocation device of claim 1, wherein the central station uses the information related to resource allocation collected from the user equipment to estimate a cell-specific required data amount vector (R_{req}), a maximum ratio of cell-specific allocatable generative equipment (uᵤₚₚ), a cell-specific channel information matrix (H), and a maximum number of generable cells (Nₐ), and initialize a number of cells to be classified as a generative cell (n (n<Nₐ)) and a cell-specific generative equipment ratio allocation vector (uᵣₐₜᵢₒ) (n=0 and uᵣₐₜᵢₒ=0).

5. The resource allocation device of claim 1, wherein the central station
calculates a bandwidth for minimizing total use power based on a cell-specific required data amount vector (R_{req}) and a cell-specific channel information matrix (H),
calculates a power value corresponding to the calculated bandwidth using a relationship formula between a bandwidth and power, and
finely adjusts the allocated bandwidth and power value and ends the resource allocation when a finally calculated power value is within a range of available power in the communication system.

6. The resource allocation device of claim 5, wherein the central station determines generative equipment and reallocates resources using a semantic generative communication (SGC) algorithm, finely tunes the allocated bandwidth and the power value, and completes the resource allocation when the calculated power value exceeds an available power amount of the communication system and thus bandwidth and power resource allocation is not allowed within an available bandwidth and power range of the communication system.

7. The resource allocation device of claim 6, wherein the SGC algorithm enables the central station to perform processes of:
initializing generative cell search,
calculating a combination of a generative cell and a generative equipment ratio,
searching for a ratio vector of the generative equipment, and
optimizing a required data amount and resources.

8. The resource allocation device of claim 7,
wherein the process of initializing generative cell search is a process of:
setting the number n of generative cells to 1 in an initial stage of the SGC algorithm, and
executing a stage of forcibly reducing the required data amount and completing the fine-tuning and resource allocation for the allocated bandwidth and the power value when the number n exceeds a maximum number Nₐ of generable cells in the communication system.

9. The resource allocation device of claim 7, wherein the process of calculating a combination of a generative cell and a generative equipment ratio is a process of calculating a set A={a₁, . . . , aₖ, . . . , a_{K}} of combinations in which n generative cells are selectable from among a total of Nₐ generable cells when the number n of generative cells and the maximum number Nₐ of generable cells satisfy n≤Nₐ, and calculating a combination of generative equipment ratio vectors U=[u₁, . . . , uₗ, . . . , u_{L}].

10. The resource allocation device of claim 7,
wherein the process of searching for a generative equipment ratio vector is a process of:
starting searching for the generative equipment ratio vector from a first vector u₁ of the set U,
sequentially searching for an element aₖ of the set A using the vector uₗ,
performing comparison with the maximum ratio of generative equipment that is allocatable to the cell when each element of aₖ is selected as a generative cell (a_{k,j}=1) during this search, and updating the generative equipment ratio vector uᵣₐₜᵢₒ when the condition is satisfied, and
setting the generative equipment ratio of the cell to 0 when each element of aₖ is not selected as the generative cell during this search (a_{k,j}=0).

11. The resource allocation device of claim 7, wherein the process of optimizing the required data amount and resources is a process of updating the required data amount vector R_{req} based on a generative equipment ratio vector uᵣₐₜᵢₒ when the generative equipment ratio vector uᵣₐₜᵢₒ is completed, checking whether the bandwidth and power of each cell calculated using a preset optimization calculation formula satisfies an available power requirement of the system, completing the fine-tuning and resource allocation when the available power requirement is satisfied, and performing the search on a next combination when the available power requirement is not satisfied.

12. The resource allocation device of claim 7,
wherein, when the process of optimizing a required data amount and resources is performed, a repetition and end process can be performed, and
the repetition and end process is a process of incrementing the number n of generative cells by 1 to start searching for the generative equipment ratio vector again when the search for all combinations is completed but the resource allocation is not allowed, repeatedly performing this until the maximum number Nₐ of generable cells does not satisfy a condition n≤Nₐ, and applying a required data amount reduction algorithm to complete the resource allocation when the resource allocation is not allowed even in the case of a combination for the maximum number of generable cells (n=Nₐ).

13. A resource allocation method for a communication system, comprising:
transmitting, by a central station of the communication system, data to one or more user equipments; and
receiving, by the one or more user equipments, original data or a text prompt from the central station,
wherein the transmitting of the data to the one or more user equipments further includes
transmitting, by the central station, a text prompt having a smaller capacity corresponding to the original data to generative equipment having an embedded generative AI function among the one or more user equipments, instead of transmitting the original data, when required resources exceed available resources; and
receiving, by the generative equipment as user equipment having an embedded generative AI function, the text prompt and generating the original data corresponding to the text prompt using an embedded generative AI model.

14. The resource allocation method of claim 13, wherein, in order for the central station to transmit data to the one or more user equipments,
the central station
receives information related to the resource allocation from the user equipment, calculates a bandwidth for minimizing total use power based on the information related to the resource allocation such as a vector representing the required amount of data for all available cells and a matrix representing channel information for all available cells, calculates a power value corresponding to the calculated bandwidth using a relationship formula between a bandwidth and power, and finely adjusts the allocated bandwidth and power value and ends the resource allocation when a finally calculated power value is within a range of available power in the communication system, and
determines generative equipment and reallocates resources using a semantic generative communication (SGC) algorithm, finely tunes the allocated bandwidth and the power value, and completes the resource allocation when the calculated power value exceeds an available power amount of the communication system and thus bandwidth and power resource allocation is not allowed within an available bandwidth and power range of the communication system.

15. The resource allocation method of claim 14, wherein the SGC algorithm enables the central station to perform processes of:
initializing generative cell search,
calculating a combination of a generative cell and a generative equipment ratio,
searching for a ratio vector of the generative equipment, and
optimizing a required data amount and resources.

16. The resource allocation method of claim 15, wherein the process of initializing generative cell search is a process of:
setting the number n of generative cells to 1 in an initial stage of the SGC algorithm, and
executing a stage of forcibly reducing the required data amount and completing the fine-tuning and resource allocation for the allocated bandwidth and the power value when the number n exceeds a maximum number Nₐ of generable cells in the communication system.

17. The resource allocation method of claim 15, wherein the process of calculating a combination of a generative cell and a generative equipment ratio is a process of calculating a set A={a₁, . . . , aₖ, . . . , a_{K}} of combinations in which n generative cells are selectable from among a total of Nₐ generable cells when the number n of generative cells and the maximum number Nₐ of generable cells satisfy n≤Nₐ, and calculating a combination of generative equipment ratio vectors U=[u₁, . . . , uₗ, . . . , u_{L}].

18. The resource allocation method of claim 15, wherein the process of searching for a generative equipment ratio vector is a process of:
starting searching for the generative equipment ratio vector from a first vector u₁ of the set U,
sequentially searching for an element aₖ of the set A using the vector uₗ, performing comparison with the maximum ratio of generative equipment that is allocatable to the cell when each element of aₖ is selected as a generative cell (a_{k,j}=1) during this search, and updating the generative equipment ratio vector uᵣₐₜᵢₒ when the condition is satisfied, and
setting the generative equipment ratio of the cell to 0 when each element of aₖ is not selected as the generative cell during this search (a_{k,j}=0).

19. The resource allocation method of claim 15, wherein the process of optimizing the required data amount and resources is a process of updating the required data amount vector R_{req} based on a generative equipment ratio vector uᵣₐₜᵢₒ when the generative equipment ratio vector uᵣₐₜᵢₒ is completed, checking whether the bandwidth and power of each cell calculated using a preset optimization calculation formula satisfies an available power requirement of the system, completing the fine-tuning and resource allocation when the available power requirement is satisfied, and performing the search on a next combination when the available power requirement is not satisfied.

20. The resource allocation method of claim 15,
wherein, when the process of optimizing a required data amount and resources is performed, a repetition and end process can be further performed, and
the repetition and end process is a process of incrementing the number n of generative cells by 1 to start searching for the generative equipment ratio vector again when the search for all combinations is completed but the resource allocation is not allowed, repeatedly performing this until the maximum number Nₐ of generable cells does not satisfy a condition n≤Nₐ, and applying a required data amount reduction algorithm to complete the resource allocation when the resource allocation is not allowed even in the case of a combination for the maximum number of generable cells (n=Nₐ).
